(19) United States
(12) Patent Application Publication
(10) Pub. No.: US 2008/0177634 A1
(43) Pub. Date: Jul. 24, 2008

(54) Method for transmitting cash register information by the internet

(76) Inventor: Raymond Payette, Quebec (CA)

Correspondence Address: RAYMOND PAYETTE, 3475 VAUTELET #306, QUEBEC, QC, G1W 4V9, omitted

(21) Appl. No.: 11/656,201

(22) Filed: Jan. 23, 2007

(51) Int. Cl. G06Q 30/00

(52) U.S. Cl. 705/21

(57) ABSTRACT

A system and a method for transmitting by the Internet cash register information to a customer. The cash register looks up the customer's digital record, updates it with the current sales, selects an appropriate protocol, attaches additional information and sends the current sales information with the additional information to the customer's Internet address.

### TECHNICAL FIELD

The present invention relates generally to cash registers, and more particularly to a system and a method for transmitting digital sales information by the Internet to a customer.

### BACKGROUND OF THE INVENTION

Electronic sales are done completely digitally; the customer usually sends an email to the seller who prepares a digital order, then a digital shipping notice and a digital receipt that he sends to the customer. The seller may use the information to inform the customer of various promotions.

Store sales are generally recorded by cash registers that accumulate information on current sales and on daily sales. Frequently these cash registers are interconnected by a local area network (LAN) to a server. Often a customer has a record in a database that can be accessed by the server. Usually the seller retains digital information that can be analyzed to maintain adequate stock levels and to study consumers' behaviors. Shoppers who buy products or services are usually handed a printed receipt of what they bought, the prices of each purchase and their total, the tax paid and the date and time of the purchase. If the consumer wants to make any calculation he needs to do it mentally or he has to input the information in a computer or a calculator; the information is “dead” until it is transformed into a digital form. It would be very beneficial to willing customers to obtaining the digital information without having to re-enter because it saves time and prevents errors.

Additional information such as the nutritional components of alimentary goods, recipes, conservation precautions or promotions and discounts tailored on the customer's habits could be added to the digital information; the seller would benefit from this economical form of advertising and the customer would obtain enriched information in a digital way that could help him better manage his purchases.

### SUMMARY OF THE INVENTION

It is an object of this invention to provide a system for storing cash register sales in a digital form, to associate them with a customer and to transmit it to him via the Internet.

It is another object of this invention to provide a system for storing cash register sales in a digital form, to associate them with a customer, to add additional digital information that can be useful to the customer or the seller and to transmit it to him via the Internet.

It is another object of this invention to provide a method for sending via the Internet information from a cash register to a customer comprising the steps of storing cash register sales in a digital form, associating them with a customer record, adding additional digital information that can be useful to the customer or the seller and transmitting this enriched information to the customer via the Internet. In accordance with an exemplary embodiment of the present invention, a customer purchases goods or services from a seller who records the transaction with a cash register. The seller requires identification information that can include the customer's phone number for example. That information is matched to the customer's record already recorded that typically contains his phone number, his name and home address, his email address and may include some of the customer's preferences. The current sale is then added to the customer's record. If the customer's preferences allow it, additional information is attached to the current sales' information and they are sent to the customer via the Internet according to the agreed protocol. This protocol may use current email protocol such as a POP3, HTTP, FTP or other.

This method can be used to record deposits or down payments for future delivery. The essence of this method is that there must be a link between the cash register and the Internet in order to retain digital information in a digital format.

It must be emphasized that this is not a payment method, though means of payments may be sent according to the customer's preferences.

### BRIEF DESCRIPTION OF THE DRAWING

FIG. 1 is a flowchart of a method illustrating the Internet transmission of a cash register sale.

### DETAILLED DESCRIPTION

In an exemplary embodiment of the present invention, cash registers are interconnected to a local area network (LAN) and to a server. Some databases including the products' database and the customers' database are also connected to the server. When a sales is recorded details are retrieved from the products' database to complete the invoice and when the sale is completed the invoice is added to the customer's record; most frequently only the total sales are recorded. Total sales, taxes perceived, shipping information and credit information is also recorded for administrative purposes.

The present invention consist of adding supplemental information such as nutritional values, guarantees, instructions, warnings, links to suppliers, promotions and publicity to the current invoice as requested by the instructions of the customer that are found in his record. This enriched invoice is then sent to the client using Internet according to a protocol agreed upon and specified in the customer's file, such as HTTP, FTP, POP3.

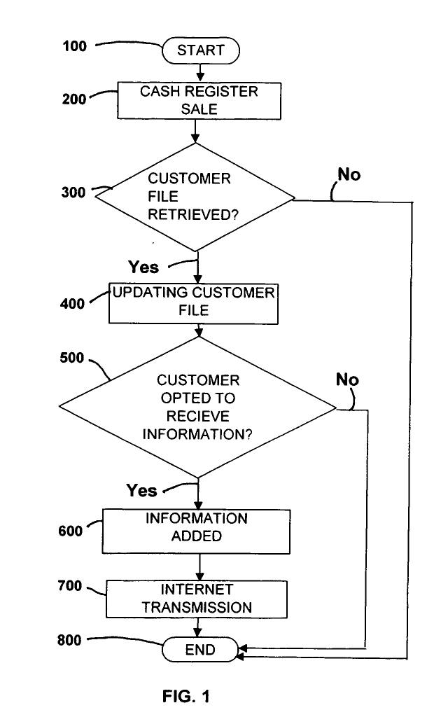

FIG. 1 is a flowchart of a method for transmitting cash register information by the Internet. The method starts at 100 when a cash sale is about to be recorded. At step 200 the sales items are recorded in the cash register. At step 300 there is an attempt to retrieve the customer's record. If the record is not retrieved, the process ends at step 800. If the record is retrieved, the record is updated with the current sale at step 400. If the customer did not opt to receive information by the Internet 500, flow ends at step 800. Additional information enriches the customer's record at step 600. Then at step 700, using an Internet protocol, enriched information is sent to the customer. The flow then stops at step 800.

In compliance with the statute, the invention has been described in a language more or less specific as to structure and methods features. It is to be understood, however, that the invention is not limited to the specific features described, since the means herein disclosed comprise exemplary forms of putting the invention into effect. The invention is, therefore, claimed in any of its forms or modifications within the proper scope of the appended claims appropriately interpreted in accordance with the doctrine of equivalents and their applicable judicial doctrines.

Having described my invention, what I claim as new and desire to secure by Letters Patents is:

1) A system for transmitting cash register digital sales information by the Internet where the customer's record is selected, digital sales information is temporarily stored, the customer's record is updated, an Internet protocol is selected, the current sales are transmitted to the customer by the Internet using the selected protocol.

2) A system as recited in claim 1, where additional digital information is added to enrich the information and it is sent to the customer.

3) A method for transmitting cash register sales information by the Internet comprising the steps of: digitally gathering sales information, matching the customer to his digital record, selecting an Internet protocol, adding additional information to enrich the customer's shopping experience, sending by the selected Internet protocol the enriched information to the customer.
